(19) United States
(12) Patent Application Publication
(10) Pub. No.: US 2015/0227951 A1
(43) Pub. Date: Aug. 13, 2015

(54) FORECASTING HOLIDAY WEEKLY SALES PROFILES

(71) Applicant: Target Brands, Inc., Minneapolis, MN (US)

(72) Inventors: Megan L. Hawley, Roseville, MN (US); Maher Lahmar, Minneapolis, MN (US)

(73) Assignee: Target Brands, Inc., Minneapolis, MN (US)

(21) Appl. No.: 14/175,725

(22) Filed: Feb. 7, 2014

(51) Int. Cl. G06Q 30/02

(52) U.S. Cl. CPC G06Q 30/0202

(57) ABSTRACT

A “holiday” approach to forecasting department and/or corporate weekly sales profiles may be applied to weeks having shifting weekday holidays. In the United States, for example, shifting weekday holidays may include Valentine's Day, Independence Day, Thanksgiving, Christmas, and New Year's Eve/Day. The holiday approach may be applied the week before and the week including the holiday. The department weekly sales profile forecast for the holiday week may be based on a relationship between a department weekly sales profile and a corporate weekly sales profile for the holiday week for one or more previous years, and on the corporate weekly sales profile for the holiday week the last time the holiday occurred on the same day of the week.

### TECHNICAL FIELD

The disclosure relates to sales forecasting.

### BACKGROUND

Sales forecasting uses past figures to predict short-term or long-term performance. The typical sales forecast takes into account past sales data and projects that data forward into the future. The sales data may be from the most recent past, e.g., the last one or two most recent years of sales by month, or may go back several years. The sales forecast may implement one or more statistical tools to make the projection or may simply project the past sales data forward. The sales forecast may also take into account price changes, costs, economic downturns, employee turnover, changing trends and fashions, increased competition, manufacturer recalls and other factors depending upon the factors relevant to the business and/or the level of sophistication of the desired sales forecast.

### SUMMARY

This disclosure is directed to techniques for sales forecasting.

In one example, a computer-implemented method of forecasting a department weekly sales profile for a holiday week of a current year in which a holiday occurs on a particular one of seven days of the week, comprising receiving corporate weekly sales profile data for a week in which the holiday occurred from one or more previous years, receiving department weekly sales profile data for the week in which the holiday occurred from the one or more previous years, determining a relationship between the corporate weekly sales profile data and the department weekly sales profile data, receiving corporate weekly sales profile data from a previous year in which the holiday occurred on the particular one of the seven days of the week, and forecasting, by a computing device, the department weekly sales profile for the holiday week of the current year based on the relationship between the corporate weekly sales profile data and the department weekly sales profile data for the one or more previous years and on the corporate weekly sales profile data from the previous year in which the holiday occurred on the particular one of the seven days of the week.

In another example, the disclosure is directed to a system, comprising a computing device configured to determine a relationship between a corporate weekly sales profile from one or more previous years and a department weekly sales profile from one or more previous years, and configured to forecast a holiday department weekly sales profile for a week of a current year in which a holiday occurs on a particular day of the week, the forecasted holiday department weekly sales profile based on the relationship between the corporate weekly sales profile and the department weekly sales profile for the one or more previous years and on a corporate weekly sales profile from a previous year in which the holiday occurred on the particular day of the week.

In another example, the disclosure is directed to a system that computes a forecast of a holiday department weekly sales profile for a week of a current year in which a holiday occurs on a particular day of the week, comprising one or more processors, a data repository that stores corporate weekly sales profile data from one or more previous years, department weekly sales profile data from the one or more previous years, and corporate weekly sales profile data from a previous year in which the holiday occurred on the particular day of the week and the one or more processors configured to compute the holiday department weekly sales forecast based on a relationship between the corporate weekly sales profile data from the one or more previous years and the department weekly sales profile data from the one or more previous years and on the corporate weekly sales profile data from the previous year in which the holiday occurred on the particular day of the week.

In any of the examples, the holiday may be a shifting weekday holiday. The shifting weekday holiday may include at least one of Valentine's Day, Independence Day, Thanksgiving, Christmas, and New Year's Eve/Day.

The details of one or more examples are set forth in the accompanying drawings and the description below. Other features and advantages of the disclosure will be apparent from the description and drawings, and from the claims.

### BRIEF DESCRIPTION OF DRAWINGS

FIG. 1 is a block diagram illustrating an example retail setting for forecasting sales according to one or more aspects of the present disclosure.

FIG. 2 is a block diagram of a computing device configured to execute sales forecasting according to one or more aspects of the present disclosure.

FIG. 3 is a conceptual diagram illustrating example data that may be used to forecast a weekly sales profile for shifting weekday holiday weeks.

FIG. 4 is a flowchart showing an example process by which a holiday forecasting module may forecast a department weekly sales profile for a shifting weekday holiday week according to one or more aspects of the present disclosure.

FIG. 5 is a table showing example calculations that may be carried out according to one or more aspects of the present disclosure.

FIG. 6 is a table showing example sales data and example calculations that may be carried out on that sales data according to one or more aspects of the present disclosure.

FIG. 7 is a table showing example adjustments to department and/or corporate weekly sales profile data according to one or more aspects of the present disclosure.

FIG. 8 is a table showing example adjustments to department weekly sales profile forecasts according to one or more aspects of the present disclosure.

### DETAILED DESCRIPTION

Generally, aspects of the disclosure are directed to techniques for forecasting of department sales in a retail environment. More specifically, the disclosure describes an approach to forecasting daily sales percentages with respect to total sales within a week for shifting weekday holiday weeks. The forecasted daily sales percentages may, in some examples, be used to forecast weekly sales for a shifting weekday holiday week.

Throughout the disclosure, a weekly sales profile is described as a profile describing the percentage of daily sales for a week. For example, one weekly sales profile might give 15% of a week's sales falling on Sunday, 12% on Monday, etc. Another weekly sales profile might give 14% of a week's sales falling on Sunday, 13% on Monday and so on. In one example, the disclosure describes an approach to forecasting weekly sales profiles for shifting weekday holidays, that is, holidays which do not necessarily fall on the same day of the week from one year to the next.

Weekly sales for certain weeks in the year may be forecasted based on the weekly sales profiles from the same week of one or more previous years. For example, the sales for a week in June 2013 may be calculated as the average of the weekly sales profiles for the same week in 2012 and 2011. This may be referred to as a “baseline” approach to weekly sales forecasting. However, the sales for some weeks may be affected if certain holidays fall within that week. For fixed weekday holidays (that is, holidays that are always on the same day of the week, such as Memorial Day and Labor Day, which are always on a Monday, or Thanksgiving, which is always on a Thursday), this does not usually affect the weekly sales profile. However, for shifting weekday holidays, such as Valentine's Day, Independence Day (4th of July), Halloween, Christmas, and New Year's Eve/Day, the weekly sales profile from year to year may be very different depending upon which day of the week the holiday falls upon. This may be further affected by the fact that sales data for each department from the last time a holiday fell on a given day (e.g., the last time Valentine's day was on a Tuesday) may not be available (due to data storage capacity reasons, for example), or when long term trends indicate that data from 6-7 years ago may be less relevant than data that is closer in time.

In addition, certain “departments” within the corporate entity may be more greatly affected by shifting weekday holidays than other departments. For example, the departments associated with candy and jewelry may see a large difference in the weekly sales profile depending upon which day of the week Valentine's Day falls upon, whereas the department associated with office supplies may see little or no difference in the weekly sales profile.

In one example, the disclosure describes a “holiday” approach to forecasting weekly department and/or corporate sales profiles. More specifically, the disclosure describes an approach to forecasting daily sales percentages with respect to total sales within a week for shifting weekday holidays. The above-mentioned “baseline” approach may be applied for non-holiday weeks, minor holiday weeks, and non-day shifting holiday weeks. The “holiday” approach may be applied to weeks having shifting weekday holidays. In the United States, for example, shifting weekday holidays may include Valentine's Day, Independence Day, Thanksgiving, Christmas, and New Year's Eve/Day. In some examples, the holiday approach may be applied the week before and the week including the holiday. The sales profile forecast for the holiday week (and/or the week preceding the holiday week) may be based on a relationship between department weekly sales and corporate weekly sales for the holiday week for one or more previous years, and on the corporate weekly sales for the holiday week the last time the holiday occurred on the same day of the week.

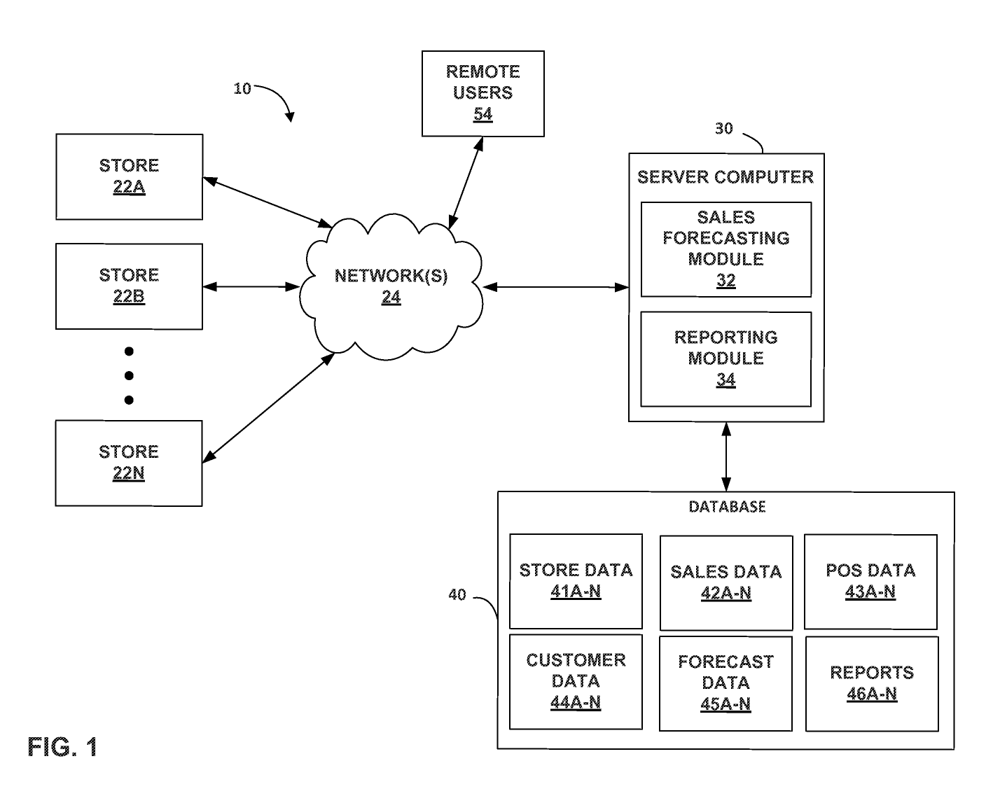

FIG. 1 is a block diagram illustrating an example communications environment 10 with which forecasting of weekly sales profiles for shifting holiday weeks of the present disclosure may be used. One or more retail stores or other facilities 22A-22N are coupled via network(s) 24 to a server computer 30. Network(s) 24 may include, for example, one or more of a dial-up connection, a local area network (LAN), a wide area network (WAN), the internet, a cell phone network, satellite communication, or other means of electronic communication. The communication may be wired or wireless. Server computer 30 is coupled to one or more local computers at each store 22A-22N via network(s) 24 to receive data related to operations at the store that is gathered and stored on local storage media at each store. Server computer 30 may also send commands, instructions, software updates, reports, data, etc. to each store via network(s) 24. Server computer 30 may receive data or otherwise communicate with the stores on a periodic basis, in real-time, on demand, upon request of server computer 30, or at any other appropriate time.

The data received from stores 22A-22N, as well as other data associated with the operation of the stores, may be stored on a data repository 40. Data repository 40 may store, for example, store data 41A-41N associated with each of stores 22A-22N, respectively; sales data 42A-42N associated with each of the stores 22A-22N, respectively; POS data 43A-43N associated with each of the stores 22A-22N, respectively; customer data 44A-44N associated with each of the stores 22A-22N, respectively; sales forecast data 45A-45N associated with each of the stores 22A-22N, respectively; and reports 46A-46N associated with each of the stores 22A-22N, respectively.

Data repository 40 may include a standard or proprietary electronic database or other data storage and retrieval mechanism. For instance data repository 40 may include one or more databases, such as relational databases, multi-dimensional databases, hierarchical databases, object-oriented databases, or one or more other types of databases. Data repository 40 may be implemented in software, hardware, and combinations of both. For example, data repository 40 may include proprietary database software stored on one of a variety of storage mediums on a data storage server connected to network 24 and configured to store information associated with sales of products or other items at various locations of a retailer. Storage media included in or employed in cooperation with data repository 40 may include, e.g., any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

Store data 41A-41N may include data that uniquely identifies or is associated with the respective store or other facility 22A-22N. As such, store data 41A-41N may include, for example, store identification information, employee information, location information, management information, additional information relating to other aspects of the corporation or operation and other information specific to each individual store 22A-22N.

Sales data 42A-42N may include, for example, past sales data associated with operation of the respective store 22A-22N. For example, sales data 42A-42N may include past sales data for each product or service sold by the retailer. For example, sales data 42A-42N may include unit sales data for each product sold by a retailer by day, week, month, or year. In addition, the sales data 42A-42N may include identifiers that permit the sales data to be analyzed by one or more departments within a store, a single store, groups of stores, all of the stores, etc.

POS data 43A-43N may include, for example, data obtained from each of stores 22A-22N, respectively, when a retail transaction is completed. As such, POS data 43A-43N may include, for example, product information, price information, discount/coupon information, customer identification information, customer payment information, date and time information, and any other information related to a retail transaction. The POS data 43A-43N may be captured using a variety of devices which may include computers, cash registers, optical and bar code scanners, magnetic card readers, tablet computers, mobile phones, or any combination of these devices. POS data 43A-43N may further include inventory data, purchasing data, receiving data, etc.

Customer data 44A-44N may include, for example, information identifying one or more customers who have made purchases at each of stores 22A-22N, respectively. The customer data 44A-44N may further include information concerning each customers method(s) of payments, products purchased, dates and times of the customer transactions, trends based on past product purchases, predictions or product suggestions for a customer, etc.

Sales forecast data 45A-45N may include, for example, data relating to sales forecasts for each of the plurality of stores 22A-22N. For example, forecast data 46A-46N may include, without limitation, predicted sales forecasts for each product sold by the respective store 22A-22N. The sales forecasts data may include predicted future product sales by day, week, month, or year. The forecast data 45A-45N may include predicted future sales data based on a single product or groups of products. The forecast data 45A-45N may further include sales forecasts for all of the stores, groups of stores, a single store, one or more departments within a store, etc. The forecast data 45A-45N may include forecasts of weekly sales profiles for shifting holiday weeks as well as non-shifting holiday weeks for each store, for groups of stores, for one or more departments within a store, etc.

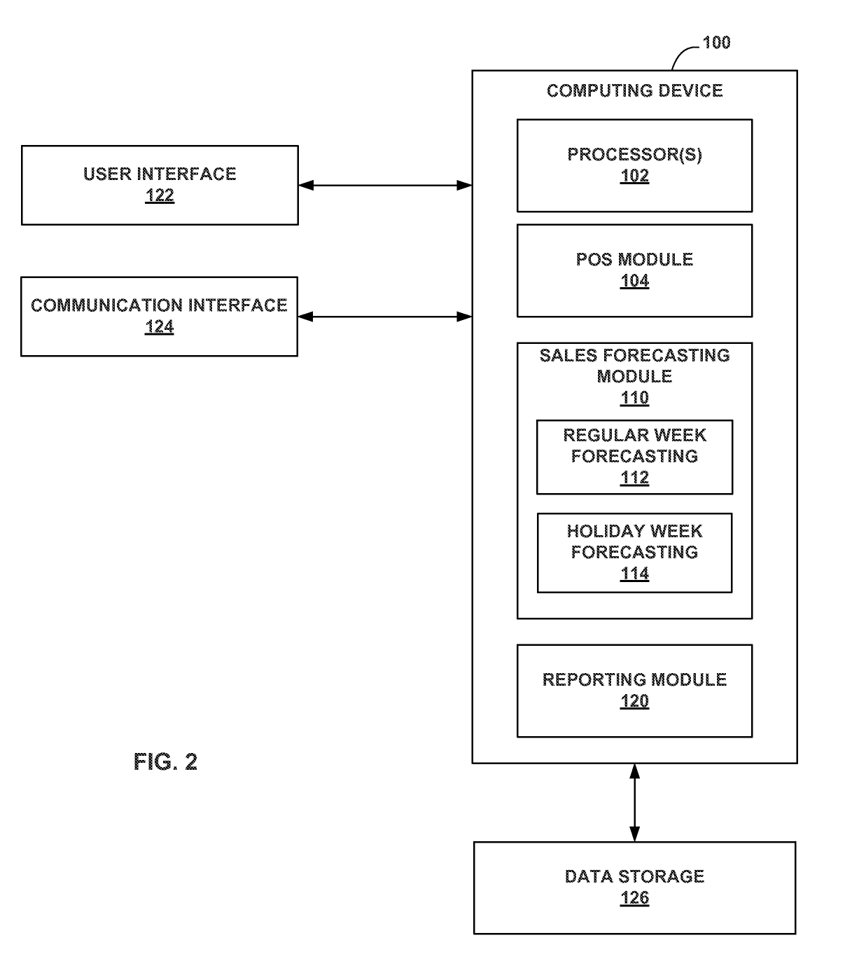

Server computer 30 includes a sales forecasting module 32 that analyzes the sales data received from each of stores 22A-22N and stores the results in data repository 40. Sales forecasting module 32 includes a regular week forecasting module to forecast weekly sales profiles for, for example, regular (non-holiday) weeks and non-shifting holiday weeks, and also includes a holiday week forecasting module (see FIG. 2) that permits sales forecasting module 32 to forecast weekly sales profiles for certain weeks based on presence of a shifting weekday holiday within those weeks. The “holiday” approach employed by the holiday week forecasting module may be applied to weeks having shifting weekday holidays. In some examples, the approach may be applied the week before and the week including the shifting weekday holiday.

A reporting application 34 generates one or more reports that present the sales data and/or the forecasted data. Reporting application 34 may generate a variety of reports to provide users local to each store 22A-22N or remote users 54 with both qualitative and quantitative data regarding raw sales and/or sales forecasts at one or more of stores 22A-22N. Reporting application 34 may also permit users to benchmark sales data and/or sales forecasts at multiple stores.

Reports 46A-46N associated with each store 22A-22N, respectively, may also be stored in data repository 40. Reports 46A-46N may be accessed by users local to each store 22A-22N or by remote users 54 over one or more network(s) 24. One or more of the reports 46A-46N may be downloaded and stored on one or more local store computing device(s), a remote user's computer 54, other authorized computing device, printed out in hard copy or further communicated to others as desired.

Remote computing devices 54 may include any number of different portable electronic mobile devices, including, e.g., cellular phones, personal digital assistants (PDA's), laptop computers, portable gaming devices, portable media players, e-book readers, watches, as well as non-portable devices such as desktop computers. Remote computing devices 54 may include one or more input/output devices configured to allow user interaction with one or more programs configured to communicate with store computers at one or more of stores 22A-22N and computing system 30. For example, remote computing devices 54 may be client computers from which users may access and interact with server computer 30 and/or one or more of stores 22A-22N. In one example, remote computing devices 54 may run a web browser that accesses and presents a web application executed by server computer system 30 or another device and allows a user to generate one or more reports including sales forecasting data. In another example, remote computing devices 54 may execute an application outside of a web browser, e.g., an operating system specific application like a Windows application or Apple OS application that accesses and presents information processed by sales forecasting module 32 or reporting module 34 on computing system 30 or another device. In another example, one or more of remote computing devices 54 may store and execute a full or reduced functionality sales forecasting module 32 and/or reporting module locally.

Local store computing device(s) or database(s) associated with each store 22A-22N may also store and analyze the above-described sales data, store data, POS data, customer data, and forecast data associated with the store. The local store computing device(s), database(s), or other local or remote computer(s), may include local sales forecasting and reporting modules such as those described above with respect to analysis and reporting applications 32 and 34. In that case, reports associated with that particular store may be generated and viewed locally. In another example, all analysis and reporting functions may be carried out remotely at server computer 30, and reports may be viewed, downloaded or otherwise obtained remotely. In other examples, some stores 22 may include local storage and/or analysis and reporting functions while other stores 22 rely on remote storage and/or analysis and reporting. Thus, although the general case of data being stored and analysis/reporting being carried out by the server computer 30 is described herein, it shall be understood that these storage, analysis and reporting functions may also be carried out locally or at some other location, or distributed amongst multiple computing devices, and that the disclosure is not limited in this respect.

FIG. 2 is a block diagram of a computing device 100 configured to forecast weekly sales profiles according to one or more aspects of the present disclosure. Computing device 100 may be used to implement server computer 30 of FIG. 1, for example, or any other computing device for use with environment 10. Computing device 100 includes one or more processors 102 that carry out functionality useful for operating a retail operation. For example, computing device 100 may include a point-of-sale (POS) module 104 that allows a retailer to carry out a retail transaction, manage inventory, run sales reports, etc. Computing device 100 also includes a sales forecasting module 110. Sales forecasting module 110 includes a regular week forecasting module 112 and a holiday week forecasting module 114. Regular week forecasting module 112 may perform sales profile forecasting for regular weeks (e.g., weeks that do not include any holidays). Regular week forecasting module 112 may also be used to forecast weekly sales profiles for minor holiday weeks (e.g., weeks including holidays that do not typically influence sales in a significant way, such as President's Day, Columbus Day, etc.) and/or non-shifting weekday holiday weeks (e.g., Memorial Day, Labor Day, and Thanksgiving).

For example, regular week forecasting module 112 may forecast weekly sales profiles based on the sales from the same week of one or more previous years. For example, the sales profile forecast for a regular week may be calculated as the average of the sales for the same week in 2012 and 2011.

Holiday week forecasting module 114 may forecast weekly sales profiles for weeks including shifting weekday holidays. In this example, the shifting weekday holidays include Valentine's Day, Halloween, Thanksgiving, Christmas and New Year's. In some examples, holiday week forecasting module 114 may be used to forecast weekly sales profiles for the shifting weekday holiday week and for the week immediately preceding the shifting weekday holiday week. In some examples, the forecast for Christmas and New Year's may be combined into a three week period that includes the week immediately preceding Christmas week, Christmas week and New Year's week.

A reporting module 120 allows computing device 100 to generate one or more reports regarding data used or generated by POS module 104, and to generate one or more reports based on data used or generated by sales forecasting module 110.

Computing device 100 may further include a user interface 122, a communication interface 124, and a data repository 126.

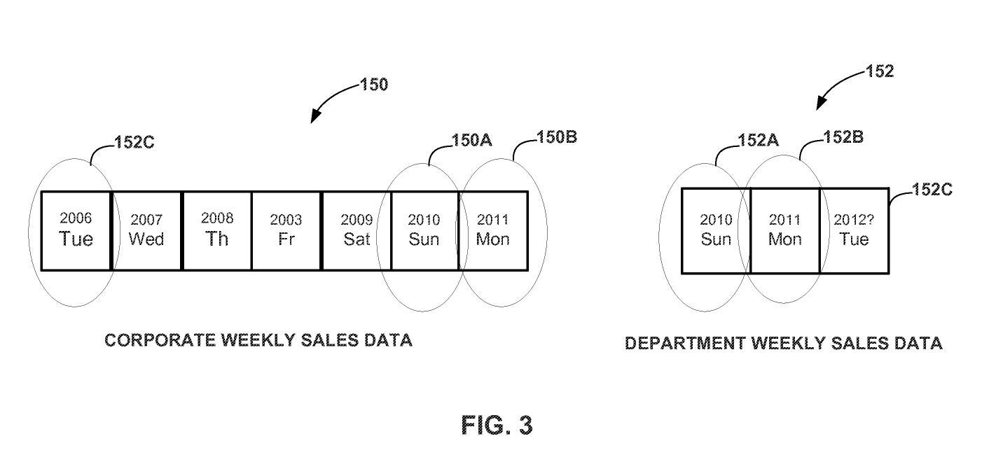

FIG. 3 is a conceptual diagram illustrating example sales data for shifting holiday weeks. Assume for purposes of this example that a forecast for a weekly sales profile for a department within a retail store is desired for the shifting holiday week for Valentine's Day week 2012 (152C). In this example, the weekly sales data includes corporate weekly sales data 150 for Valentine's Day week in each of years 2006-2011. The weekly sales data further includes department weekly sales data 152 for Valentine's Day week in each of years 2010 (150A) and 2011 (150B). As shown in the example of FIG. 1, Valentine's Day 2012 falls on a Tuesday, Valentine's Day 2011 fell on a Monday, and Valentine's Day 2010 fell on a Sunday, etc. The last time Valentine's Day fell on a Tuesday was Valentine's Day 2006.

The forecast of the weekly sales profile for Valentine's Day week 2012 (152C) may be based on several types of weekly sales data. For example, holiday week sales profile forecasting according to one or more aspects of the present disclosure may be based on the corporate weekly sales (150C) for Valentine's Day week the last time Valentine's day occurred on the same day of the week (e.g., 2006).

Holiday week sales profile forecasting according to one or more aspects of the present disclosure may further be based on the corporate weekly sales for Valentine's Day week in one or more previous years, regardless of whether Valentine's Day occurred on the same day of the week. For example, holiday week sales profile forecasting may be based on the corporate weekly sales during Valentine's Day week for the previous year (2011 in this example) and corporate weekly sales during Valentine's Day week for 2 years previously (2010 in this example).

Holiday week sales profile forecasting according to one or more aspects of the present disclosure may further be based on the department weekly sales for Valentine's Day week in one or more previous years, regardless of whether Valentine's Day occurred on the same day of the week. For example, holiday week sales profile forecasting may be based on the department weekly sales during Valentine's Day week for the previous year (2011 in this example) and department weekly sales during Valentine's Day week for 2 years previously (2010 in this example).

Although corporate and department weekly sales for one or two previous years are described in this example, it shall be understood that one or more previous year's sales data may be used depending upon the amount of data available, the relevance of data from the past, and other factors.

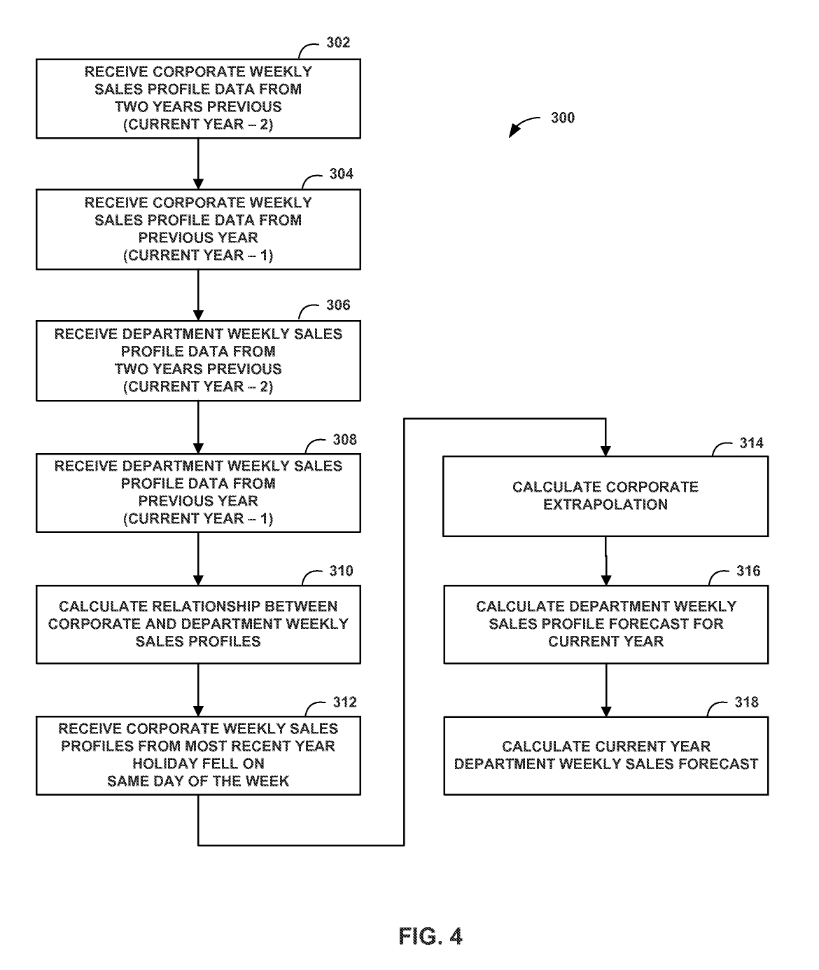

FIG. 4 is a flowchart showing an example process (300) by which a holiday forecasting module, such as holiday week forecasting module 114 of FIG. 2, may forecast a weekly sales profile for a shifting weekday holiday week. In this example, process (300) includes receiving corporate weekly sales profiles from two years previous (current year—2) (302) and receiving corporate weekly sales profiles from the previous year (current year—1) (304). Process (300) further includes receiving department weekly sales from two years previous (current year—2) (306) and receiving department weekly sales data from the previous year (current year—1) (308). For example, the corporate and department weekly sales profile data may be received by processors 102 of computing device 100 from data storage 126 in FIG. 2. Processors 102 of computing device 100 may execute the instructions contained in holiday week forecasting module 114 to forecast a weekly sales profile for a shifting weekday holiday week.

Process (300) further includes calculating a relationship between corporate and department weekly sales profiles for the shifting weekday holiday week (and also, in some examples, for the immediately preceding week) (310). For example, the weekly sales profiles for some departments may be more greatly affected than weekly sales profiles for other departments if a shifting weekday holiday falls within the week. Thus, the relationship between corporate and department weekly sales for departments whose weekly sales profiles are relatively more affected by shifting weekday holiday weeks will be different than the relationship between corporate and department weekly sales for those departments whose weekly sales are affected to a lesser degree, or not at all.

In one example, the relationship between corporate and department weekly sales percentages is a corporate to department weighted average. For example, the corporate to department weighted average for each day of the shifting weekday holiday week (and also, in some examples, for one or more immediately preceding weeks) may be calculated based on the following equation:

E=(weight₁)(C−A)+(weight₂)(D−B), where

(A) is the corporate weekly sales percentage from two years previous (current year—2),
(B) is the corporate weekly sales percentage from the previous year (current year—1),
(C) is the department weekly sales percentage from two years previous (current year—2),
(D) is the department weekly sales percentage from the previous year (current year—1), and
(E) is the corporate to department weighted average.

The corporate to department weighted average in this example thus takes into account the difference between the department percentage of weekly sales and the corporate percentage of weekly sales for the previous 2 years.

In general, the sum of weight' and weight₂ should equal 1. In one example, the weights applied in the equation for the corporate to department weighed average are:

weight₁=0.4, and

weight₂=0.6.

Assigning weights in this manner means that the weekly sales data from the most recent year is weighted more heavily than the weekly sales data from 2 years previously. This assumes that data that is closer in time is more relevant for predicting future sales than data that is farther removed in time. However, it shall be understood that the weights need not be assigned in this manner, other values (whether equal or unequal) for the weights may be used, and the disclosure is not limited in this respect. Instead, the weights be may equal (equal relevance applied to both the previous year's data and the data for 2 years previous), or they may be reversed if for some reason the data from 2 years previous is determined to be more relevant (e.g., there was an anomaly such as a snowstorm or other event which cause the previous year's data to be less relevant).

Process (300) further includes receiving corporate weekly sales percentages for each day of the holiday week from the most recent year that the holiday fell on the same day of the week (312). An extrapolated corporate weekly sales profile for the holiday week (and also, in some examples, for one or more immediately preceding weeks) may then be calculated (314). For example, the extrapolated corporate weekly sales for the holiday week may be calculated based on the following equation:

(F) corporate weekly sales percentage from the last time the holiday fell on the same day of the week

(G) extrapolated corporate weekly sales percentage:

G=E+F

The extrapolated corporate weekly sales percentage (G) in this example thus takes into account the corporate weekly sales profile data from the most recent year that the holiday occurred on the same day of the week and the difference in percentage between department and corporate weekly sales profile for the last two years. In other words, the corporate weekly sales profile data from the most recent year that the holiday occurred on the same day of the week is adjusted based on the difference in more recent department and corporate weekly sales profile data. This in effect extrapolates the weekly corporate sales profile data from the last time the holiday occurred on the same day of the week with the more recent department and corporate sales data.

Process (300) calculates the department weekly sales profile forecast for the current year (316). The department weekly sales profile forecast may take into account the department weekly sales profile for the previous year (current year −1) and the corporate extrapolation (which takes into account corporate weekly sales data from the most recent year the holiday occurred on the same day of the week). For example, the forecast of the department weekly sales profile may be calculated based on the following equation:

(H) department weekly sales forecast:

H=(weight₃)(D)+(weight₄)(G)

In general, the sum of weight₁ and weight₂ should equal 1. In one example, the weights applied in the equation for the department weekly sales forecast are:

weight₃=0.5, and

weight₄=0.5.

Assigning weights in this manner means that the department weekly sales data from the previous year and the extrapolated corporate weekly sales data are weighted equally. This assumes that the sales data for both of these are similarly relevant. However, it shall be understood that the weights need not be assigned in this manner, other values (whether equal or unequal) for the weights may be used, and that the disclosure is not limited in this respect.

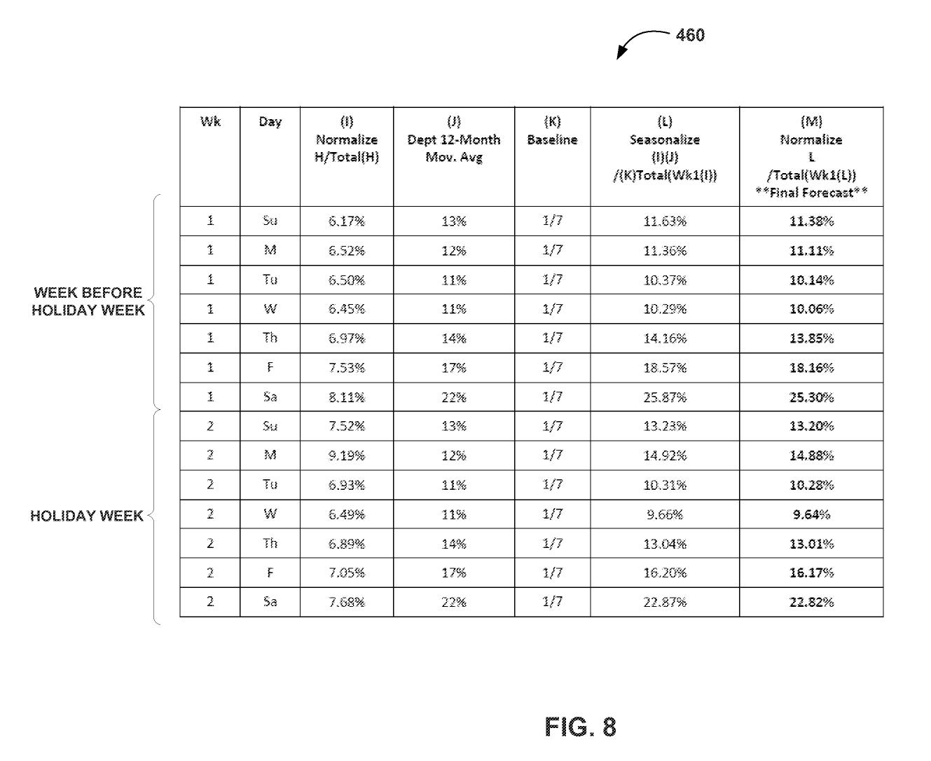

In some examples, process (300) of FIG. 4 may further forecast weekly sales (e.g., in terms of dollars, units, etc.) based on the forecasted weekly sales profile (318). For example, a daily sales multiplier for a particular day of a current week may be calculated by taking the inverse of the forecasted daily sales percentage of the sum of all previous days' percentages. Suppose we are looking at a current week and that it is Tuesday, so Tuesday's sales haven't completed yet. The process (300) may calculate a sales multiplier based on the forecasted weekly sales profile to forecast sales for the current week. This is described in further detail with respect to FIG. 8.

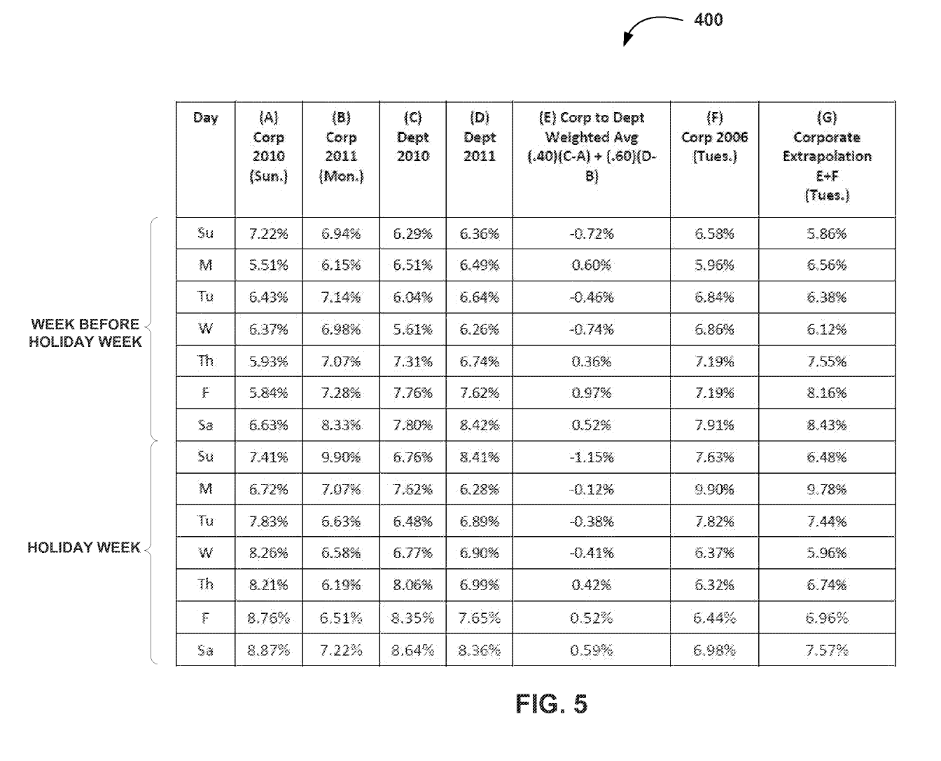

FIG. 5 is a table 400 showing example sales data and example calculations that may be carried out on that sales data according to one or more aspects of the present disclosure. The first column of table 400 lists the days of the week for each of the weeks for which a weekly sales profile forecast is to be calculated. In this example, a weekly sales profile forecast is calculated for the holiday week and also for the week before (immediately preceding) the holiday week. The second column (A) corresponds to corporate weekly sales profile data from two years previous (current year—2, or 2010 in this example). The third column labeled (B) corresponds to corporate weekly sales profile data from the previous year (current year—1, or 2011 in this example). The fourth column labeled (C) corresponds to department weekly sales profile data from two years previous (current year—2, or 2010 in this example). The fifth column labeled (D) corresponds to department weekly sales profile data from the previous year (current year—1, or 2011 in this example).

In this example, columns two through five (labeled (A)-(D)) include sales profile data for each day of the respective week expressed as a percentage of sales for the total two-week time period. Thus, the corporate sales for the Sunday of the week before the holiday week from two years before the current year (2010) were 7.22% of the total corporate sales for the two-week period in this example. Similarly, the department sales for the Tuesday of the holiday week from the previous year (2011) were 6.89% of the total department sales for the two-week period in this example. It shall be understood that sales data may be expressed in ways other than as the percentages shown here, and that different time ranges may be taken into account, and that the disclosure is not limited in these respects.

The sixth column labeled (E) corresponds to the corporate to department weighted average. In this example, the corporate to department weighted average (E) is calculated using the equation given above. Thus, the corporate to department weighted average for the Monday of the holiday week is −0.12% in this example. This corporate to department weighted average is indicative of a relationship between the department weekly sales and the corporate weekly sales for the holiday week and the week immediately preceding the holiday week for the previous two years.

The seventh column labeled (F) corresponds to corporate weekly sales profile data from the last time the holiday fell on the same day of the week (2006 in this example). In this example, column seven (F) includes corporate sales profile data for each day of the respective week expressed as a percentage of sales for the total two-week time period. Thus, the corporate sales for the Monday of the holiday week from the most recent year the holiday occurred on the same day of the week (2006) were 9.90% of the total corporate sales for the two-week period in this example.

The eighth column labeled (G) corresponds to the extrapolated corporate weekly sales profile. In this example, the extrapolated corporate weekly sales profile (G) is calculated using the equation given above. The extrapolated corporate weekly sales profile in this example thus takes into account the corporate weekly sales profile data from the most recent year that the holiday occurred on the same day of the week and the difference in percentage between department and corporate weekly sales profile data for the last two years. Thus, the extrapolated corporate weekly sales for the Monday of the holiday week is 9.78% of the total corporate sales for the two-week period in this example (9.90+(−0.12)=9.78).

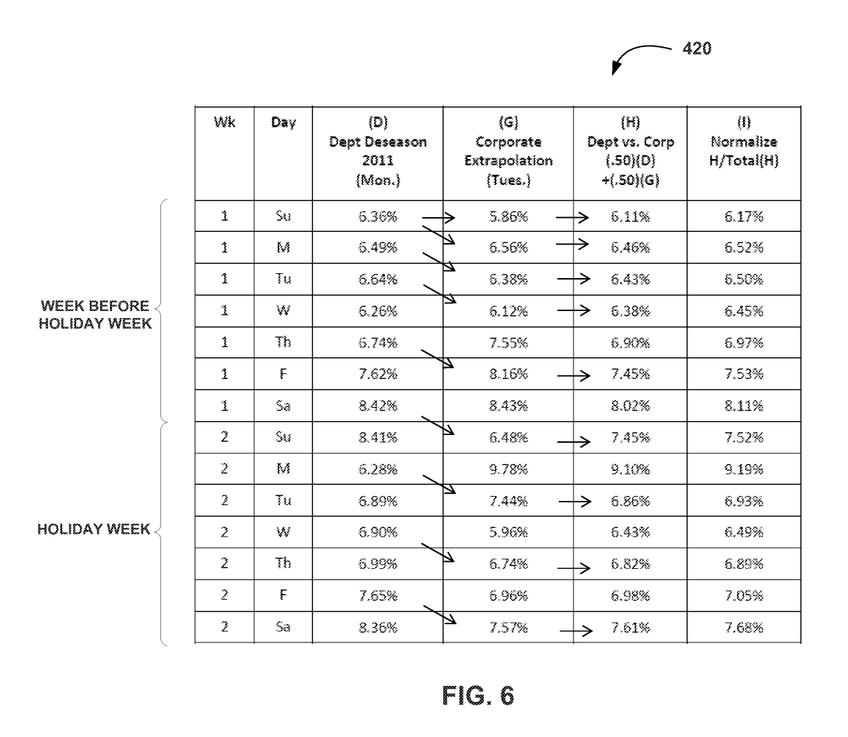

FIG. 6 is a table 420 showing example sales profile data and example calculations that may be carried out on that sales profile data according to one or more aspects of the present disclosure. The first column lists whether corresponding row is associated with the first week (in this example, the week immediately preceding the holiday week) or the second week (in this example, the holiday week). As with FIG. 5, the second column of table 420 lists the days of the week for each of the weeks for which a forecast of the weekly sales profile is to be calculated. In this example, a sales forecast is calculated for the holiday week and also for the week before (immediately preceding) the holiday week. The third column (D) includes the same data as column (D) from FIG. 5 and corresponds to the department weekly sales profile data from the previous year (current year—1, or 2011 in this example). The fourth column (G) includes the extrapolated corporate weekly sales profile data (G) from FIG. 5.

The fifth column (H) is the department weekly sales profile calculated for the current year (2012). In this example, the department weekly sales profile takes into account the department weekly sales profile for the previous year (current year—1) and the corporate extrapolation (which takes into account corporate weekly sales profile data from the most recent year the holiday occurred on the same day of the week), and is calculated using the equation described above. Column (H) also takes into account how the weekly sales profile shifts due to the holiday. The Dept Deseasonalized sales (D) don't take into account how the daily sales percentages will shift due to the holiday. To arrive at (H), the holiday approach uses a weighted amount of the percentage of weekly sales from the last time holiday fell on the same day of the week (D) and adds it to the weighted corporate extrapolation (G). To calculate (G) for Sunday of the first week, the calculation uses the Sunday of the first week since the data in this example only includes the week preceding the holiday week. Thus, in this example, the department weekly sales profile forecast (H) for the Monday of the holiday week for the current year (2012) is 9.10% (0.58.41)+0.59.78)=9.10.

In some examples, the department weekly sales profile forecast may be normalized such that the total of the percentage of sales over the two week time period is equal to 100%. In this example, the normalized department weekly sales profile forecast is shown in sixth column (labeled (I) of FIG. 6.

In addition, in some examples, the department and/or corporate weekly sales profile data (for example, columns (A), (B), (C), (D), and (F) of FIG. 5 and column (D) of FIG. 6) may be adjusted before the calculations for the department weekly sales forecast are executed. For example, the department and corporate weekly sales profile data may be adjusted in various ways to account for changes in sales over time, to account for variations in sales attributable to the day of the week, to account for seasonality, etc.

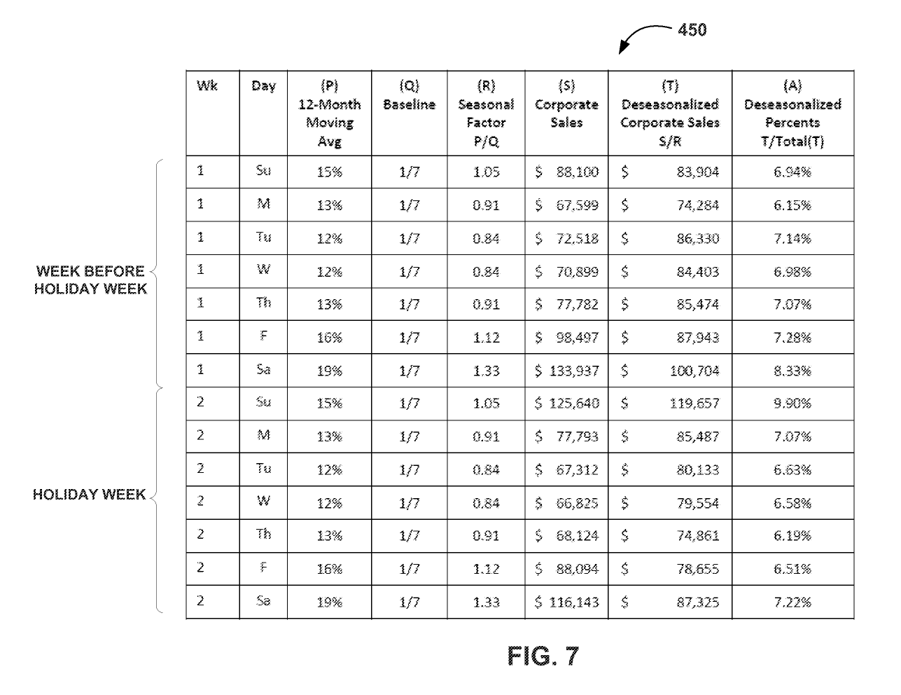

FIG. 7 is a table 450 showing example adjustments to department and/or corporate weekly sales profile data according to one or more aspects of the present disclosure. Specifically, FIG. 7 shows adjustment to corporate weekly sales profile data for the year preceding the current year (2011 in this example). The first and second column of table 450 list the week number (first or second week) and days of the week, respectively, for each of the weeks for which a forecast is to be calculated. In this example, a weekly sales profile forecast is calculated for the holiday week and also for the week before (immediately preceding) the holiday week.

The third column (P) of table 450 corresponds to a 12-month moving average that takes into account changes in daily sales percentages over time. For example, the corporate sales data may show that the percentage of sales for a particular day of the week has been changing over time. The trend in the daily sales percentage may be generally increasing, generally decreasing, or generally stable. In table 450, for example, the 12-month moving average for Sunday of the week immediately preceding the holiday week is 15%.

The fourth column (Q) of table 450 is a baseline factor that takes into account the fraction of days per week for each day of the week. Thus in this example, the retailer is open for business seven days of the week, this factor is 1/7 for each of days Sunday-Saturday. The fifth column (R) is a seasonal factor that takes into account the differences in sales based on the day of the week. In the example of table 450, the seasonal factor for Sundays is 1.05 and the seasonal factor for Mondays is 0.91. This accounts for the fact that sales for this example retailer are generally higher on Sundays than they are on Mondays.

The sixth column (S) corresponds to actual corporate weekly sales data (in US dollars) for the previous year (current year—1, or 2011 in this example). Thus, in this example, the total corporate weekly sales for Sunday of the week immediately preceding the holiday week was $88,100. The seventh column (T) corresponds to the deseasonalized corporate weekly sales data (in US dollars). In this example, the deseasonalized corporate weekly sales data is calculated using the following equation:

T=S/R.

The last column (A) corresponds to the deseasonalized percents (e.g., the weekly sales profile) for the corporate weekly sales data corresponding to the two-week period including the holiday week and the week immediately preceding the holiday week. Column (A) of table 450 corresponds to Column (A) of table 400 in FIG. 5. Similar calculations may also be performed on corporate weekly sales data for one or more previous years to arrive at deseasonalized corporate weekly sales profile data such as that shown in columns (B) and (F) of FIG. 5. Similar calculations may also be performed on department weekly sales data for one or more previous years to arrive at deseasonalized department weekly sales profile data such as that shown in columns (C) and (D) of FIG. 1. It shall be understood, however, that the deseasonalizing calculations shown in FIG. 5 need not be performed in all examples, or that only certain calculations or other calculations may be performed, and that the disclosure is not limited in this respect.

FIG. 8 is a table 460 showing example adjustments to a department weekly sales profile forecast (H) according to one or more aspects of the present disclosure. Specifically, FIG. 7 shows adjustment to department weekly sales profile forecast for the current year (2012 in this example). The first and second column of table 460 list the week number (first or second week) and days of the week, respectively, for each of the weeks for which a weekly sales profile forecast is to be calculated. In this example, a weekly sales profile forecast is calculated for the holiday week and also for the week before (immediately preceding) the holiday week.

The third column (I) of table 460 is the normalized department weekly sales profile forecast corresponding to column (I) of FIG. 6. Various adjustments may be applied to the normalized department weekly sales profile forecast to take into account for changes in sales over time, to account for variations in sales attributable to the day of the week, to account for seasonality, etc. Thus, the calculations shown in table 460 essentially add these effects back into the final department weekly sales profile forecast that were removed as shown with respect to table 450 in FIG. 7.

For example, the fourth column (J) corresponds to a department 12-month moving average that takes into account changes in daily department sales percentages over time. The fifth column (K) corresponds to column (Q) of FIG. 7 ( 1/7 for each day of the week in this example).

The sixth column (L) is the seasonalized department weekly sales profile forecast. In this example, the seasonalized department weekly sales profile forecast is calculated using the following equation:

L=(I)(J)/(K)(Total(Wk1(I)).

This calculation factors the most recent seasonalized data into account by using columns (J) and (K) and formulates the numbers out of a one-week percent instead of a two-week percent. The purpose of this is that the final forecast (M) is expressed in terms of one-week percentages.

The seventh column (M) corresponds to an example department weekly sales profile forecast expressed in terms of one-week percents for the holiday week and the week immediately preceding the holiday week. In this example, the “final” department weekly sales forecast includes seasonalization and normalization of the normalized department weekly sales forecast. Thus, in this example, the normalized and seasonalized department weekly sales profile forecast (M) is calculated using the following equation:

M=L/Total(Wk1(L)).

This calculation normalizes the data in one-week percentages. When factoring in the seasonalized data, the percentages may add up to less than or more than 100%. Normalizing these one week at a time results in the department weekly sales profile forecast expressed in terms of one-week percents for the holiday week and the week immediately preceding the holiday week.

Thus the final department weekly sales profile forecast for the Monday of the holiday week is 14.88% expressed as a percentage of sales for the one-week period the day falls in.

As mentioned above with respect to FIG. 4, in some examples process (300) may further forecast weekly sales (e.g., in terms of dollars, units, etc.) based on the forecasted weekly sales profile (318). For example, a daily sales multiplier for a particular day of a current week may be calculated by taking the inverse of the forecasted daily sales percentage of the sum of all previous days' percentages. In the example of FIG. 8, suppose it is currently Tuesday of the holiday week, so Tuesday's sales haven't completed yet. The process (300) may calculate a sales multiplier based on the forecasted weekly sales profile to forecast sales for the current week. In the example of FIG. 8, suppose the retailer has sold $150 Sunday and Monday of this week. The combined forecasted sales percentages for Sunday and Monday of the holiday week are 28.08% (13.2+14.88=28.08). The multiplier for Tuesday of the holiday week would then be 1/0.2808=3.56. The process (300) may then take the sales from Sunday and Monday of the current holiday week (e.g., $150) and the multiplier from the forecasted sales percentages (3.56) to arrive at a forecast for the current holiday week's sales (150*3.56=$534.00). Thus, the process (300) may forecast weekly sales based on actual sales from the sum of the previous day's forecasted sales percentages and the actual sales from the previous days.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media. In some examples, an article of manufacture may comprise one or more computer-readable storage media.

In some examples, computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A computer-implemented method of forecasting a department weekly sales profile for a holiday week of a current year in which a holiday occurs on a particular one of seven days of the week, comprising:
receiving corporate weekly sales profile data for a week in which the holiday occurred from one or more previous years;
receiving department weekly sales profile data for the week in which the holiday occurred from the one or more previous years;
determining a relationship between the corporate weekly sales profile data and the department weekly sales profile data;
receiving corporate weekly sales profile data from a previous year in which the holiday occurred on the particular one of the seven days of the week; and
forecasting, by a computing device, the department weekly sales profile for the holiday week of the current year based on the relationship between the corporate weekly sales profile data and the department weekly sales profile data for the one or more previous years and on the corporate weekly sales profile data from the previous year in which the holiday occurred on the particular one of the seven days of the week.

2. The computer-implemented method of claim 1 wherein the holiday is a shifting weekday holiday.

3. The computer-implemented method of claim 2 wherein the holiday includes one of Valentine's Day, Independence Day, Thanksgiving, Christmas, and New Year's Eve/Day.

4. The computer-implemented method of claim 1 wherein determining a relationship between the corporate weekly sales profile data and the department weekly sales profile data includes computing a corporate to department weighted average.

5. The computer-implemented method of claim 4 wherein the corporate to department weighted average is computed according to the equation:
E=(weight₁)(C−A)+(weight₂)(D−B), where
(A) is a percentage of corporate weekly sales from two years previous (current year—2),
(B) is a percentage of corporate weekly sales from the previous year (current year—1),
(C) is a percentage of department weekly sales from two years previous (current year—2),
(D) is a percentage of department weekly sales from the previous year (current year—1), and
(E) is the corporate to department weighted average.

6. The method of claim 5 wherein weight₂ is greater than weight₁.

7. The computer-implemented method of claim 5 further including calculating an extrapolated corporate weekly sales percentage according to the equation:
G=E+F, where
(F) is the percentage of corporate weekly sales from the previous year in which the holiday occurred on the particular one of the seven days of the week, and
(G) is the extrapolated corporate weekly sales percentage.

8. The computer-implemented method of claim 7 further including forecasting the department weekly sales profile based on the equation:
H=(weight₃)(D)+(weight₄)(G), where
(H) is the department weekly sales forecast.

9. The computer-implemented method of claim 4 wherein the sum of weight₂ and weight₁ equals 1.

10. The computer-implemented method of claim 1 wherein the weekly sales profile data from a most recent year of the one or more previous years is weighted more heavily than the weekly sales profile data from a less recent year of the one or more previous years.

11. The computer-implemented method of claim 1 wherein the one or more previous years includes a first year that immediately precedes the current year and a second year that is two years preceding the current year.

12. The computer-implemented method of claim 1 further comprising computing a plurality of department weekly sales forecasts for the holiday week, each corresponding to a different one of a plurality of departments associated with a corporate entity.

13. The computer-implemented method of claim 1 further comprising forecasting weekly sales for the holiday week based on the forecasted department weekly sales profile.

14. The computer-implemented method of claim 1 further wherein the forecasted department weekly sales profile is expressed in terms of one-week percents for the holiday week and the week immediately preceding the holiday week.

15. A system, comprising:
a computing device configured to determine a relationship between a corporate weekly sales profile from one or more previous years and a department weekly sales profile from one or more previous years, and configured to forecast a holiday department weekly sales profile for a week of a current year in which a holiday occurs on a particular day of the week, the forecasted holiday department weekly sales profile based on the relationship between the corporate weekly sales profile and the department weekly sales profile for the one or more previous years and on a corporate weekly sales profile from a previous year in which the holiday occurred on the particular day of the week.

16. The system of claim 15 wherein the holiday is a shifting weekday holiday.

17. The system of claim 15 wherein the holiday includes at least one of Valentine's Day, Independence Day, Thanksgiving, Christmas, and New Year's Eve/Day.

18. A system that computes a forecast of a holiday department weekly sales profile for a week of a current year in which a holiday occurs on a particular day of the week, comprising:
one or more processors;
a data repository that stores corporate weekly sales profile data from one or more previous years, department weekly sales profile data from the one or more previous years, and corporate weekly sales profile data from a previous year in which the holiday occurred on the particular day of the week; and
the one or more processors configured to compute the holiday department weekly sales forecast based on a relationship between the corporate weekly sales profile data from the one or more previous years and the department weekly sales profile data from the one or more previous years and on the corporate weekly sales profile data from the previous year in which the holiday occurred on the particular day of the week.

19. The system of claim 18 wherein the holiday is a shifting weekday holiday.

20. The system of claim 18 wherein the holiday includes at least one of Valentine's Day, Independence Day, Thanksgiving, Christmas, and New Year's Eve/Day.
